(19) United States
(12) Patent Application Publication
(10) Pub. No.: US 2025/0155385 A1
(43) Pub. Date: May 15, 2025

(54) Object Manipulator for an X-ray Inspection System

(71) Applicant: Comet Yxlon GmbH, Hamburg (DE)

(72) Inventors: Laurenz Rosemann, Hamburg (DE); Andreas Mecke, Hamburg (DE)

(21) Appl. No.: 18/941,109

(22) Filed: Nov. 8, 2024

(30) Foreign Application Priority Data
Nov. 10, 2023 (DE) 10 2023 131 273.1

(51) Int. Cl. G01N 23/20025

(52) U.S. Cl. CPC G01N 23/20025; G01N 2223/309; G01N 2223/32; G01N 2223/3307

(57) ABSTRACT

An object manipulator for an X-ray inspection system is disclosed. The object manipulator has an object stage on which a test object can be secured, a first linear guide along which the object stage can be moved in a first direction, and a second linear guide along which the object stage can be moved in a second direction. The second direction has a perpendicular component relative to the first direction, particularly being perpendicular thereto, an object stage interface being formed on the first linear guide. The object stage has an interface region in which it is detachably connected to the object stage interface via a connecting device. The object stage has a support region in which it is arranged on the first linear guide to be positionally movable thereon and which is spatially separate from the interface region, in particular at its end facing away from the interface region.

### PRIORITY CLAIM

The present application claims priority under 35 U.S.C. § 119 to German Patent Application No. DE 10 2023 131 273.1, filed Nov. 10, 2023, the disclosure of which is incorporated by reference herein in its entirety.

### TECHNICAL FIELD

The present disclosure relates to an object manipulator for an X-ray inspection system with an object stage on which a test object can be secured.

### DESCRIPTION OF STATE OF THE ART

Non-destructive inspection of test objects using X-rays involves using X-ray systems that use an X-ray tube and an X-ray detector as an imaging system. The test object to be inspected must be able to be placed in the beam path and moved within it. In order to be able to move it, it is attached to an object manipulator that is able to move it linearly along different traverse axes and rotate it about different rotation axes, the respective required directions and rotation axes depending on the procedure to be performed (in rotary laminography, for example). In the object manipulator that has been used to date, an object stage on which the test object can be secured rests on a thin object stage support. This thin object stage support cannot be manufactured with high precision. What is more, the object stage support also bends under higher loads. Both of these factors mean that the stage cannot be positioned stably or aligned properly with the traverse axes, the rotation axes, and the central beam of the X-ray source. The stages are normally positioned using two pins in holes on the object stage support. Depending on the tolerance of the pins or the holes in which the pins are inserted, the stage may move when the axes are moved on the object stage support. When changing or replacing the stage, the position of the stage may change. This makes it impossible to achieve adequate positioning repeatability, and the adjustment of the object stages relative to the traverse and rotation axes or to the central beam of the X-ray inspection system is complex. The same applies due to different degrees of deflection of the object stage support for test objects of different weights.

### SUMMARY

It is the object of the present disclosure to provide an object manipulator in which the positioning repeatability is improved after changing an object stage.

The object is achieved according to the present disclosure by an object manipulator. Advantageous embodiments are specified in the subclaims.

The object is achieved according to the present disclosure by an object manipulator having an object stage that has a first linear guide and a second linear guide along which the object stage can be moved in two directions—these are usually selected so as to be perpendicular to one another and referred to as the X- and Z-directions—, an object stage interface being formed on the first linear guide, and the object stage having an interface region in which it is detachably connected to the object stage interface via a connecting device, the object stage also having a support region in which it is arranged on the first linear guide in a manner as to be positionally movable thereon and that is spatially separate from the interface region—the support region being preferably formed at its end facing away from the interface region. By replacing the previous thin object stage support, which tends to bend and thus did not yield good reproducibility with test objects of different weights arranged on different stages, with a stage that is significantly more dimensionally stable than the object stage support and is supported on the first linear guide without the object stage support being inserted, the positioning repeatability accuracy is optimized when changing or replacing the object stage. In addition, the object stage can be manufactured with high precision, unlike in the manufacture of the object stage support hitherto used.

One advantageous refinement of the disclosed embodiments makes a provision that the first linear guide has two parallel guide rails and/or the second linear guide has two parallel guide rails, the guide rails being particularly round or rectangular linear shafts. This means that it is not necessary to use the linear guides known from the prior art, which have to be manufactured as cost-intensive production parts, but that more cost-effective solutions in the form of purchased parts can be used instead.

Another advantageous refinement of the disclosed embodiments makes a provision that the connecting device has two screws, in particular clamping screws, which interact with the object stage interface and the interface region. This ensures extremely reliable, exact positioning of the replaced object stage at the location where the previous object stage was located. The positioning repeatability accuracy is therefore extremely high, and an unwanted change in the relative position of the object stage relative to the first linear guide is impossible.

Another advantageous refinement of the disclosed embodiments makes a provision that the connecting device has a first stop (e.g., stop means) and a third stop at the object stage interface and has a second stop and a fourth stop at the interface region, the second stop being pressed against the first stop, and the fourth stop being pressed against the third stop by a pressing device. Since, due to the pressing device, the stop cannot move in the plane spanned by the first and second directions of the two linear guides—which is usually referred to as the XZ-plane of the object manipulator—the same extremely reliable exact positioning of the replaced object stage at the location where the previous object stage was located is achieved as by means of the embodiment explained in the previous paragraph. Consequently, even with the embodiment described in this paragraph, the positioning repeatability accuracy is extremely high.

Another advantageous refinement of the disclosed embodiments makes a provision that the first stop and the third stop are each a linear shaft or a cylindrical pin that extends substantially perpendicular to the first direction and the second direction, and where the second stop is a straight stop edge that extends along the first direction, and where the fourth stop is a body that has a first stop surface and a second stop surface, the respective orientation of which has a directional component that is not parallel to the stop edge, and one directional component has a positive angle relative to the second direction and the other directional component has a negative angle relative to the second direction, the angle between the two orientations being in particular 90°. This ensures the exact, repeatable positioning of the replaced object stage using very simple means, and the system is not overdetermined, so that it fits precisely on the intended contact surfaces. The force of the pressing device presses the object stage with its contact edge and the two stop surfaces against the linear shafts or the cylindrical pins, whereby no movement of the object stage is possible in the direction of the plane spanned by the two linear guides as described above, the XZ-plane of the object manipulator.

Another advantageous refinement of the disclosed embodiments makes a provision that at least one of the linear shafts or the cylindrical pins is movable relative to the object stage interface in a direction that has a component in the second direction, and/or the straight stop edge is movable in a direction that has a component in the second direction. If, for example, the linear shaft or the cylindrical pin interacting with the stop edge is moved, the object stage rotates around the other linear shaft or the other cylindrical pin; the same applies if the stop edge is moved accordingly. If one employs the regular designation of the directions (see above), this corresponds to a rotation around the Y-direction, i.e., perpendicular to the plane spanned by the object stage. Such a rotation enables the alignment of contact edges and horizontal rotation axes around the first direction (usually the X-direction) and the second direction (usually the Z-direction).

Another advantageous refinement of the disclosed embodiments makes a provision that the pressing device has a spring that has a force component along the second direction, and the pressing device is in particular a lateral pressure piece. Such an implementation is especially simple and possible using means that are already available on the market.

Another advantageous refinement of the disclosed embodiments makes a provision that the manipulator has both a connecting device in the form of two screws and a connecting device with first to fourth stop. This combines the respective advantages of the abovementioned embodiments.

Another advantageous refinement of the disclosed embodiments makes a provision that two bearing bodies, in particular rotating wheels, are arranged on the object stage interface that support the movement of the object stage interface along with the object stage along the first direction, with at least one of these bearing bodies, preferably both bearing bodies, being movable in a third direction that has both a perpendicular component relative to the first direction and a perpendicular component relative to the second direction, the third direction being preferably perpendicular to the first direction and the second direction. If both bearing bodies are adjusted equally, rotation occurs around the first direction (usually the X-direction). If only one of the bearing bodies or both bearing bodies are adjusted differently, a rotation around the second direction (usually the Z-axis) occurs. This is only a minimal change in height, which in practice has only a very minor impact, but the second rotation then does not take place exactly in this second direction; instead, due to the torsion of the object stage, the result is a rotation around a line parallel to the Z-axis. In addition to the rotating wheels mentioned above as possible bearing bodies, any and all other known bearing bodies for roller bearings can also be used; a plain bearing is also possible instead of a roller bearing, in which case known plain bodies can be used as the bearing body.

Another advantageous refinement of the disclosed embodiments makes a provision that at least one of the two bearing bodies is movable via an eccentric device. Such a embodiment can be adjusted very finely using commercially available tools.

### BRIEF DESCRIPTION OF THE DRAWINGS

Further details and advantages of the present disclosure will now be explained in greater detail with reference to exemplary embodiments illustrated in the drawings, in which:

FIG. 1 is a schematic representation of a known X-ray inspection system with denoted axes and directions of movement of a manipulator.

FIG. 2 shows an exemplary embodiment of a manipulator according to some embodiments in a perspective view.

FIG. 3 shows a schematic section through the manipulator from FIG. 2.

FIG. 4 shows a portion of a second exemplary embodiment of a manipulator according to some embodiments in a plan view.

FIG. 5 shows the portion according to FIG. 4 in a refinement.

FIG. 6 is a side view of the refinement according to FIG. 5 viewed in the Z-direction with information on the rotation around a line parallel to the X-axis.

FIG. 7 shows a schematic section of the refinement of FIGS. 5 and 6 perpendicular to the X-axis.

FIG. 8 is a side view like FIG. 6 with information on the rotation around a line parallel to the Z-axis.

### DETAILED DESCRIPTION

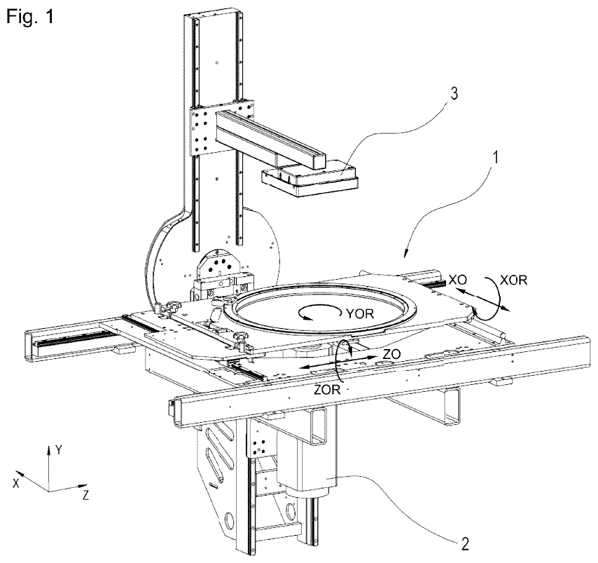

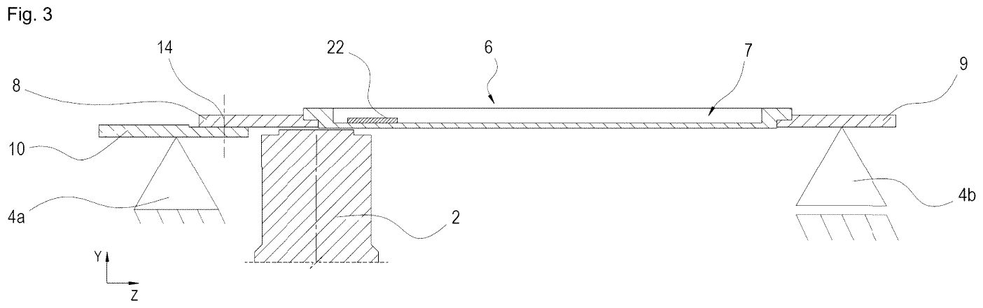

FIG. 1 shows a schematic example of the structure of an X-ray inspection system. It has an X-ray tube 2 that emits an X-ray beam (not shown) and, opposite thereto, an X-ray detector 3 that detects the X-rays from the X-ray source 2. An object manipulator 1 is arranged therebetween to which a test object 22 (see FIG. 3) can be secured that is illuminated by the X-ray beam. The possibilities for moving the X-ray tube 2 and the X-ray detector 3 are not essential to the disclosed embodiments, so they are not shown.

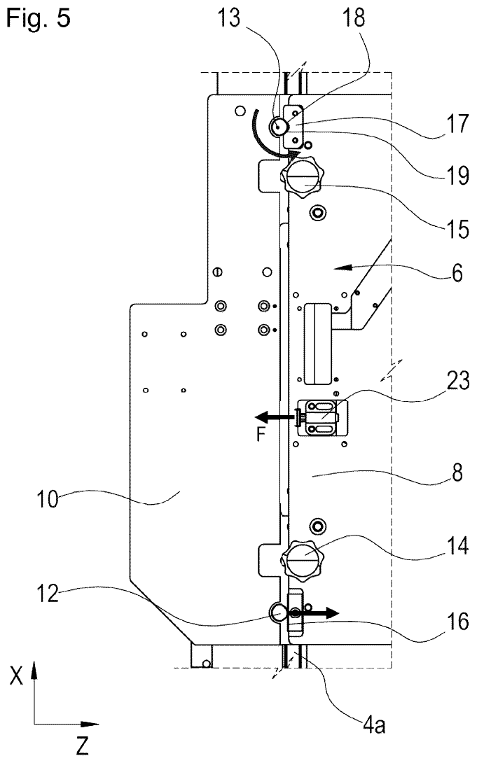

A Cartesian coordinate system is specified, the orientation of which corresponds to the usual practice, but a different orientation is also possible. The Y-axis extends vertically in the direction of the X-ray radiation emitted by the X-ray tube 2. The Y- and Z-directions run parallel to the plane spanned by the surface of the object manipulator 1. With regard to the disclosed embodiments, the possible linear and rotational—movements of an object stage 6 (see FIGS. 5 to 8) are indicated. These are the linear movements parallel to the X-axis (referred to as XO), the Y-axis (referred to as YO), and the Z-axis (referred to as ZO), and the rotational movements around an axis parallel to the X-axis (referred to as XOR), the Y-axis (referred to as YOR), and the Z-axis (referred to as ZOR).

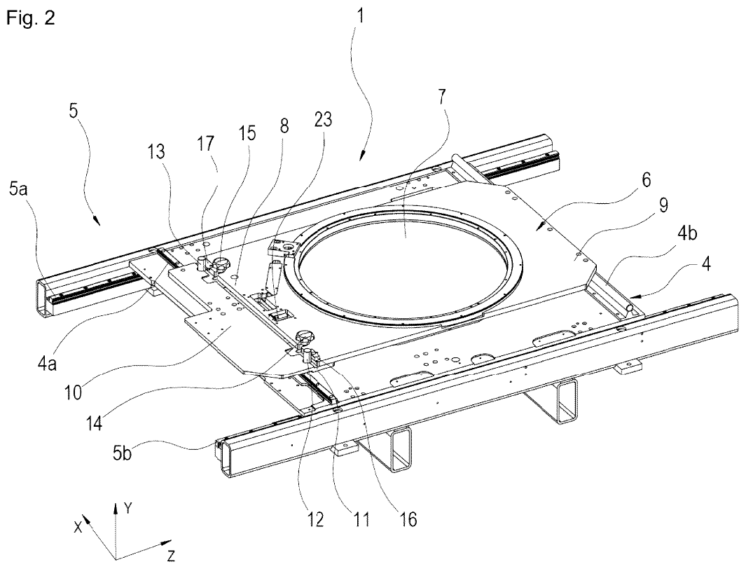

In FIG. 2, an inventive construction of an object manipulator 1 is shown in a perspective view. It extends substantially (except for its height in the Y-direction) in a plane that is parallel to the XZ-plane. The explanations for FIG. 2 do not yet fully explain the functionality of the parts shown and how they interact; this will be discussed further below in the explanations for the other figures.

The lowest layer of the manipulator 1 forms a second linear guide 5 having two parallel guide rails—a third guide rail 5a and a fourth guide rail 5b. A first linear guide 4 is arranged on this second linear guide 5 that has two parallel guide rails—a first guide rail 4a (in the form of a profile rail 4a) and a second guide rail 4b (in the form of a round linear shaft 4b). The guide rails 4a, 4b of the first linear guide 4 are aligned perpendicular to the guide rails 5a, 5b of the second linear guide 5.

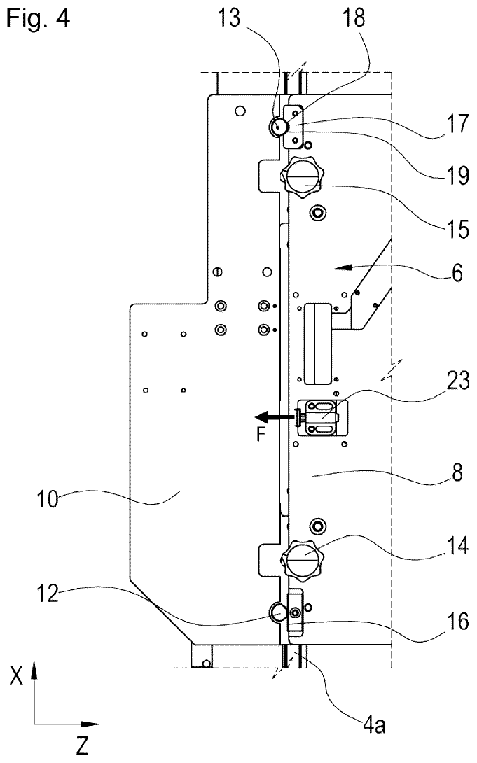

An object stage 6 is arranged on the first linear guide 4 that is movable along the first and second guide rails 4a, 4b. The object stage 6 rests with its one end, which is referred to below as the support region 9, on the second guide rail 4b via bearing bodies that are not designated in more detail and are not shown. The end thereof facing away from the support region 9, which is referred to below as the interface region 8, is detachably connected to an object interface 10. The connection is realized via two clamping screws 14, 15 and a system of four stops (e.g., stop means) 12, 13, 16, 17 and a pressing device 23 (further details on this and the interaction of these parts can be found below in relation to FIGS. 4 and 5). A receiving recess 7—which is circular, for example—is formed in the object stage 6 in which the test object 22 (see FIG. 3) can be secured to the object stage 6.

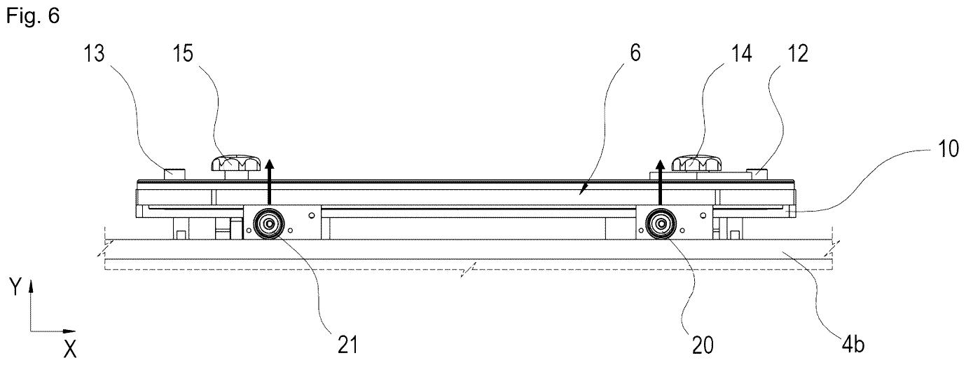

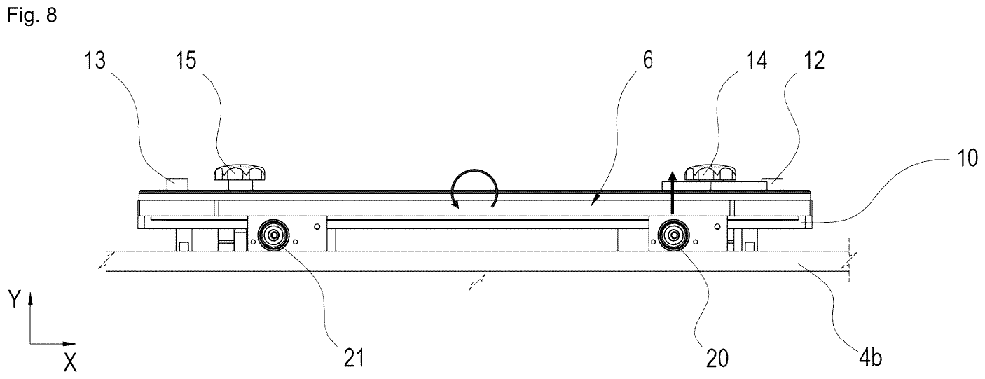

The object stage interface 10 is movably connected to the second guide rail 4b via bearing bodies 20, 21, which are shown in FIGS. 6 and 8. The object stage interface 10 has in its vicinity (to the right in FIG. 2) a step 11 on which the interface region 8 of the object stage 6 rests. The first and third stops 12, 13 are attached to the object stage interface 10, while the second stop 16 and the fourth stop 17 are attached to the object stage 6.

FIG. 3 shows a highly schematic section through the object manipulator 1 parallel to the YZ-plane. The object stage 6 rests on the two guide rails 4a, 4b running perpendicular to the drawing plane. This is directly the case in the support region 9, and in the interface region 8 via the object stage interface 10. To ensure that the object stage 6 is secured to the object stage interface 10, these two parts are connected by the two clamping screws 14, 15. This rules out a relative movement between the object stage 6 and the object stage interface 10—and hence of the first linear guide 4 and the second linear guide 5 of the object manipulator 1. Regardless of what type of object stage 6 is installed in the manipulator after it has been replaced, its position and thus the position of the test object 22 secured in its receiving recess 7 is precisely determined, so that no inaccuracies/errors in the reconstruction of the test object 22 from the data obtained during the X-ray inspection are possible during the X-ray inspection of the test object 22 due to positioning inaccuracies. This makes it possible to change the object stage easily without having to laboriously readjust the object manipulator 1 after the change has been made. The X-ray tube 2, which can be moved relative to the object stage 6, is shown below the object stage 6.

Unlike the prior art, which employed a circumferential object stage support in contact with both guide rails 4a, 4b into which the object stage 6 was inserted, the abovementioned advantages are achieved by the inventive use of only one object stage interface 10 interacting on one side with the first guide rail 4a of the first linear guide 4 in conjunction with the direct interaction of a part of the object stage 6 (its support region 9) with the second guide rail 4b of the first linear guide 4. Unlike the hitherto used object stage support made of thin metal sheet, the solid object stage 6 can be manufactured with high precision. Due to its solid design, there is no bending in the Y-direction when test objects 22 have different weights, unlike the previous use of an object stage support.

FIG. 4 shows a portion of the object stage 6 in its interface region 8 in connection with the object stage interface 10 in plan view (counter to the Y-direction). In addition to the two clamping screws 14, 15 described in more detail above, which prevent a relative movement between the object stage 6 and the object stage interface 10 after an exact alignment of the object stage 6 at the object stage interface 10, exact alignment is possible by means of an additional construction.

This construction is achieved by use of four stops (e.g., stop means) 12, 13, 16, 17 in conjunction with a pressing device 23, the effect of which is shown by the force arrow denoted by F. The pressing device 23 presses (for example by a spring force) the object stage 6 to the left against the secured object stage interface 10, so that the second stop 16 is pressed into contact with the first stop 12 and the third stop 17 is pressed into contact with the second stop 13. For example, a lateral pressure piece can be used as the pressing device 23 that functions in such a way that, when the object stage 6 is inserted from above (i.e., counter to the Y-direction) into the object manipulator 1 when connected to the object stage interface 10, the deflection of the weight force (which develops against the Y-direction due to gravity) of the object stage 6 is converted into a spring force F perpendicular thereto (which runs counter to the Z-direction). As a result of this spring force F, the object stage 6 is then moved as explained above counter to the Z-direction against the object stage interface 10, so that the stops 12, 13, 16, 17 lead to the spatial positioning of the object stage 6 at the object stage interface 10. Instead of using pressing devices 23 with a mechanical force (such as the spring force F mentioned above as an example), pressing devices 23 can also be used that employ pneumatic or any other type of force.

The first and third stops 12, 13 formed in the object stage interface 10 are embodied as first cylindrical pins 12 and second cylindrical pins 13, respectively, which extend along the Y-direction. Instead of using cylindrical pins 12, 13, the first and third stops 12, 13 could, for example, each be embodied as a linear shaft. The second stop 16 is embodied as a stop edge 16 whose stop surface is aligned parallel to the XY-plane. The fourth stop 17 is embodied as a body having two stop surfaces at an angle to each other, a first stop surface 18 and a second stop surface 19. In the exemplary embodiment that is illustrated, this angle is 90°, but this is not limiting. The two contact surfaces 18, 19 extend perpendicular to the plane of the sheet, so that the second cylindrical pin 13 can interact with the two stop surfaces 18, 19 over a longer area. Due to the two stop surfaces 18, 19 and the straight stop edge 16 (in conjunction with the two cylindrical pins 12, 13), the system is not overdetermined, i.e., it abuts in a defined manner.

In addition, the object stage 6 can be screwed to the object stage interface 10 using the two clamping screws 14, 15. This is useful if the force F is exceeded, for example as a result of an additional force in the X-direction, since then a movement and thus a change in the position of the object stage 6 is prevented by the two clamping screws.

A rotation of the object stage 6 relative to the object stage interface 10 can take place about axes parallel to the X-, Y-, and Z-axes if this is necessary for adjustment.

FIG. 5 shows how a rotation around a line parallel to the Y-axis can be achieved. FIG. 5 is very similar to FIG. 4, but the stop element 16 is linearly movable in the Z-direction. If such a movement occurs in the Z-direction, the stop edge 16 is moved to the right, for example (as shown by the arrow). Since the second cylindrical pin 13 is stationary, the object stage 6 rotates counterclockwise relative to the object stage interface 10 about the axis defined by the second cylindrical pin 13, as shown by the curved arrow in FIG. 5. The rotation around this axis enables the alignment of contact edges and the horizontal rotation axes ZOR parallel to the linear axes XO and ZO, respectively (for the axis designations, see FIG. 1).

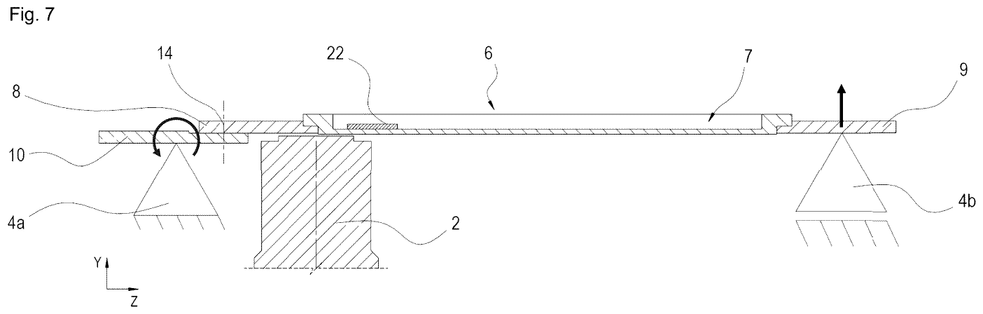

FIGS. 6 and 7 show how a rotation can occur around an axis parallel to the X-axis. This figure is a view counter to the Z-direction, i.e., from the right in FIG. 2. On the second guide rail 4b, which is embodied in the form of a round linear shaft 4b, the object stage 6 runs parallel to the X-axis. The clamping screws 14, 15 and cylindrical pins 12, 13, which are not relevant for this movement, can also be seen. In order to be able to carry out the linear movement of the object stage 6 in the X-direction with as little friction as possible, two bearing bodies are provided—a first bearing body 20 on the right and a second bearing body 21 on the left—which are each embodied in the form of a carriage with a running wheel that is adjustable in height—i.e., in the Y-direction—relative to the object stage 6. The height adjustment can be carried out, for example, by means of an eccentric, in which case it is the same size on the two bearing bodies 20, 21.

FIG. 7 shows a highly schematic view of the manipulator 1 in the X-direction. On the left, the first guide rail 4a, which is embodied in the form of a profile rail 4a, is shown as it interacts with the object stage interface 10 and the object stage 6, and on the right, the movement of the support region 9 of the object stage 6 due to the previously described height adjustment by the two eccentrically operated bearing bodies 20, 21 is shown (illustrated by the arrow). This results in a counterclockwise rotational movement around the axis formed by the first guide rail 4a (indicated by the curved arrow).

FIG. 8 shows how a rotation around a line parallel to the Z-axis can be achieved. FIG. 8 corresponds essentially to FIG. 6. However, the height of the two bearing bodies 20, 21 is now not changed by the same amount, but only the height of the first bearing body 20 is adjusted relative to the object stage 6 (this is done in the same way as described above for FIGS. 6 and 7). As stated above, this is only a minimal change in height, which in practice has only a very minor impact. The second rotation does not then take place exactly about an axis parallel to the Z-direction, but due to the torsion of the object stage 6, the result is an approximate rotation of the object stage 6 about an axis parallel to the Z-direction, as shown by the curved arrow.

A combined rotation about axes parallel to the X- and Z-axes—as shown in FIGS. 6 to 8—enables the alignment of an axis of the object stage 6 (here the YOR axis shown in FIG. 1) parallel to the central beam, i.e., parallel to the Y-axis.

### LIST OF REFERENCE SYMBOLS

1 Object Manipulator
2 X-ray tube
3 X-ray detector
4 first Linear Guide
4a first Guide Rail, Profile Rail
4b second Guide Rail, Linear Shaft
5 second Linear Guide
5a third Guide Rail
5b fourth Guide Rail
6 Object Stage
7 Receiving Recess
8 Interface Region
9 Support Region
10 Object Stage Interface
11 Step
12 first Stop, first Cylindrical Pin
13 third Stop, second Cylindrical Pin
14 Clamping Screw
15 Clamping Screw
16 second Stop, stop Edge
17 fourth Stop
18 first Stop Surface
19 second Stop Surface
20 first Bearing Body
21 second Bearing Body
22 Test Object
23 Pressing Device

1. An object manipulator for an X-ray inspection system, comprising:
an object stage on which a test object is configured to be secured;
a first linear guide along which the object stage is movable in a first direction;
a second linear guide along which the object stage is movable in a second direction, wherein the second direction has a perpendicular component relative to the first direction;
wherein an object stage interface is formed on the first linear guide;
wherein the object stage has an interface region in which it is detachably connected to the object stage interface via a connecting device;
wherein the object stage has a support region in which it is arranged on the first linear guide in a manner as to be positionally movable thereon and which is spatially separated from the interface region.

2. The object manipulator according to claim 1, wherein the first linear guide has two parallel guide rails, and wherein the guide rails are round or rectangular linear shafts.

3. The object manipulator according to claim 1, wherein the second linear guide has two parallel guide rails, and wherein the guide rails are round or rectangular linear shafts.

4. The object manipulator according to claim 1, wherein the connecting device has two screws that interact with the object stage interface and the interface region.

5. The object manipulator according to claim 1, wherein the connecting device has a first stop and a third stop on the object stage interface and has a second stop and a fourth stop on the interface region, wherein the second stop is pressed against the first stop and the fourth stop is pressed against the third stop by a pressing device.

6. The object manipulator according to claim 5, wherein the first stop and the third stop are each a linear shaft or a cylindrical pin that extends substantially perpendicular to the first direction and the second direction, and wherein the second stop is a straight stop edge that extends along the first direction, and wherein the fourth stop is a body that has a first stop surface and a second stop surface, a respective orientation of which has a directional component that is not parallel to the straight stop edge, and one directional component has a positive angle relative to the second direction and the other directional component has a negative angle relative to the second direction.

7. The object manipulator according to claim 6, wherein at least one of the linear shafts or one of the cylindrical pins is movable relative to the object stage interface in a direction that has a component in the second direction.

8. The object manipulator according to claim 6, wherein the straight stop edge is movable in a direction that has a component in the second direction.

9. The object manipulator according to claim 5, wherein the pressing device comprises a spring having a force component along the second direction, and the pressing device is a lateral pressure piece.

10. The object manipulator according to claim 1, wherein the object manipulator includes both a connecting device that has two screws that interact with the object stage interface and the interface region and a connecting device that has a first stop and a third stop on the object stage interface and has a second stop and a fourth stop on the interface region.

11. The object manipulator according to claim 1, wherein two bearing bodies are arranged on the object stage interface that support movement of the object stage interface along with the object stage along the first direction, wherein at least one of these bearing bodies is movable in a third direction that has both a perpendicular component relative to the first direction and a perpendicular component relative to the second direction.

12. The object manipulator according to claim 11, wherein at least one of the two bearing bodies is movable via an eccentric device.
